(19) United States
(12) Patent Application Publication
(10) Pub. No.: US 2025/0282937 A1
(43) Pub. Date: Sep. 11, 2025

(54) BIODEGRADABLE COMPOSITES FOR PACKAGING

(71) Applicants: MARS, INCORPORATED, McLean, VA (US); GEORGIA TECH RESEARCH CORPORATION, Atlanta, GA (US)

(72) Inventors: Eric H. KLINGENBERG, McLean, VA (US); James Carson MEREDITH III, Atlanta, GA (US); Natalie STINGELIN, Atlanta, GA (US); Yang LU, Atlanta, GA (US)

(73) Assignees: MARS, INCORPORATED, McLean, VA (US); GEORGIA TECH RESEARCH CORPORATION, Atlanta, GA (US)

(21) Appl. No.: 19/105,007

(22) PCT Filed: Aug. 18, 2023
(86) PCT No.: PCT/US2023/030622

§ 371 Date: Feb. 19, 2025

Related U.S. Application Data
(60) Provisional application No. 63/399,489, filed on Aug. 19, 2022.

(51) Int. Cl. C08L 1/02; C08J 7/048; C08K 3/013; C08K 5/092; C08L 5/08

(52) U.S. Cl. CPC C08L 1/02; C08J 7/048; C08K 3/013; C08K 5/092; C08L 5/08; C08J 2301/02; C08J 2305/08; C08L 2201/06; C08L 2203/16; C08L 2312/06

(57) ABSTRACT

The present disclosure relates to renewable composites as high oxygen and high moisture barriers for packaging. In certain embodiments, the renewable composite comprises cellulose nanocrystals (CNC) and chitin (Ch). In other embodiments, the renewable composite comprises CNC. Ch. and one or more cross-linkers.

### CROSS REFERENCE TO RELATED APPLICATIONS

This application claims priority to U.S. Patent Application Ser. No. 63/399,489 filed on Aug. 19, 2022, which is incorporated herein by reference in its entirety.

### TECHNICAL FIELD

The present disclosure relates to materials for packaging, and more particularly to biodegradable composites as high oxygen and high moisture barriers for packaging and methods for producing the same.

### BACKGROUND

Petrochemical plastics as barriers are widely used in packaging of food, pharmaceuticals, electronics, etc. However, the widespread usage of fossil-based plastics has resulted in a heavy burden on the environment. By 2015, more than 6.3 billion tons of plastic waste has been generated. 79% of plastic waste ends up in landfills or natural environment like ocean and only less than 14% of plastic was recycled (Geyer R, Jambeck J R, Law K L. Production, use, and fate of all plastics ever made. Science Advances 2017, 3 (7)). These petrochemical plastics are extremely durable under these conditions as complete degradations requiring over hundreds to thousands of years (Brahney J, Hallerud M, Heim E, Hahnenberger M, Sukumaran S. Plastic rain in protected areas of the United States. Science 2020, 368 (6496), 1257-1260).

As such, a transition to biodegradable plastics sourced from renewable biomass has been promoted as the best solution to combat plastic pollution. Great progress has been made as the share of biodegradable plastics such as cellulose-based material and polylactic acid (PLA) in packaging materials is continuously growing. In 2020, the consumption of bioplastics reached 2.1 million tons, 47% of which was used for packaging (Syberg K, Nielsen M B, Westergaard Clausen L P, van Calster G, van Wezel A, Rochman C, Koelmans A A, Cronin R, Pahl S, Hansen S F. Regulation of plastic from a circular economy perspective. Current Opinion in Green and Sustainable Chemistry, 2021, 29).

However, the vast majority of plastics used in packaging is still petrochemical plastics due to two major challenges: the existing biodegradable plastic are deficient in barrier properties required for most of packaging applications and higher cost compared with petrochemical plastics. To evaluate the barrier performance, oxygen permeability (OP) and thickness normalized water vapor transmission rate (N-WVTR) are commonly used. Low OP and N-WVTR values indicate good barrier properties.

Accordingly, there remains a need for a renewable material with low OP and N-WVTR values to replace petrochemical plastics for packaging. Further, there is a need to provide methods for producing the same with reduced cost, manufacturing time, and energy consumption. The presently disclosed subject matter addresses these and other needs.

### SUMMARY

The present disclosure relates to biodegradable composites for packaging and methods for producing the same.

In certain embodiments, the presently disclosed subject matter provides a biodegradable composite comprising cellulose nanocrystals (CNC) and chitin (Ch), wherein the Ch having a degree of acetylation (DA) from about 40% to about 95%, and wherein, at 23° C., 50% relative humidity (RH), the biodegradable composite having an oxygen permeability equal to or lower than about 4 cm³ μm m⁻² d⁻¹ kPa⁻¹ and a water vapor transmission rate (WVTR) equal to or lower than about 18 g mm m⁻² d⁻¹.

In certain embodiments, the Ch has DA from about 40% to about 70%. In certain embodiments, the composite is a cross-linked material. In particular embodiments of the composite, the CNC and the Ch are cross-linked with one another through ionic bonds, electrostatic interactions, and/or hydrogen bonds. In certain embodiments, an absolute biodegradation of the biodegradable composite is at least 50% after 65 days in aerobic environment. In certain embodiments, the composite further comprises one or more fillers, wherein a weight ratio between the one or more fillers and a total weight of CNC and Ch is from about 1% to about 99%. In particular embodiments of the composite, the one or more fillers are nano-clays, talcum, or calcium carbonate.

In certain embodiments, the Ch is produced by deacetylation of chitin. In certain embodiments, a weight ratio between the CNC and Ch is from about 1:0 to about 0:1. In particular embodiments of the composite, the weight ratio between the CNC and the Ch is about 1:1.

In certain embodiments, the biodegradable composite further comprises a cross-linker. In particular embodiments, the cross-linker is citric acid. In other particular embodiments, the cross-linker is propane-1,2,3,-tricarboxylic acid and/or adipic acid. In certain embodiments, the composite is exposed to a form of energy, wherein the form of energy comprises ultraviolet (UV) irradiation, gamma irradiation, or heat.

The disclosed subject matter also provides a method for producing a biodegradable composite, the method comprising: forming a cellulose nanocrystal (CNC) suspension; preparing chitin (Ch) powder from deacetylation of chitin powder; forming a Ch liquid mixture; mixing the CNC suspension and the Ch liquid mixture to form a mixture suspension; coating the mixture suspension on a substrate; and air-drying the mixture suspension to obtain a CNC/Ch composite film.

In certain embodiments, the Ch liquid mixture is a Ch solution or a Ch suspension. In certain embodiments, prior to coating mixture suspension on the substrate, the method further comprising degassing in an ultrasonic bath. In certain embodiments, wherein a concentration of the CNC suspension is about 0.5 wt. % and a concentration of the Ch liquid mixture is about 0.5 wt. %.

The disclosed subject matter also provides a method for producing a biodegradable composite, the method comprising: forming a cellulose nanocrystal (CNC) aqueous suspension; preparing soluble chitin (Ch) powder from deacetylation of chitin powder; forming a Ch solution; mixing the CNC aqueous suspension, the Ch solution, and one or more cross-linkers to form a mixture suspension; coating the mixture suspension on a substrate; air-drying the mixture suspension; and heat-drying the mixture to obtain a CNC/Ch/cross-linker composite film. In certain embodiments, the one or more cross-linkers are at least one of citric acid, propane-1,2,3,-tricarboxylic acid, and adipic acid.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1A is an exemplary illustration of the structure of cellulose nanocrystals (CNC)/chitin (Ch) composite film in accordance with certain non-limiting embodiments of the disclosed subject matter. FIG. 1B is an exemplary illustration of the cross-linking structure between CNC and Ch polymer chains in CNC/Ch composite in accordance with certain non-limiting embodiments of the disclosed subject matter.

FIGS. 2A and 2B show the structures of CNC and Ch. FIG. 2A is polymer structures of cellulose and CNC, e.g., sulfonated cellulose. FIG. 1B is polymer structures of Ch and chitosan.

FIGS. 3A-3C are exemplary illustrations of the cross-linking structures between citric acid (CA) and Ch/Ch polymer chains (3A), between CNC/CNC polymer chains (3B), and between CNC/Ch polymer chains (3C), respectively. FIG. 3D is Fourier-transform infrared (FT-IR) spectra of 1:1 CNC/Ch-L, 1:1 CNC/Ch-EL, 1:1 CNC/Ch-L/20% CA, and 1:1 CNC/Ch-EL/30% CA samples.

FIGS. 4A and 4B are exemplary illustrations of the cross-linking structure between tricarboxylic acid (TCA) and CNC/Ch polymer chains (4A) and between adipic acid (Ad) and CNC/Ch polymer chains (4B), respectively. FIG. 4C is FT-IR spectra of 1:1 CNC/Ch-L, 1:1 CNC/Ch-EL/15% Ad, 1:1 CNC/Ch-EL/15% TCA-Ad (10-90), and 1:1 CNC/Ch-EL/15% TCA-Ad (25-75) samples.

FIG. 5 provides an exemplary method for making a biodegradable composite in accordance with certain non-limiting embodiments of the disclosed subject matter.

FIGS. 6A-6D are scanning electron microscope (SEM) images of Ch-H (A, B) and Ch-EL (C, D) in accordance with certain non-limiting embodiments of the disclosed subject matter.

FIGS. 7A, 7B, and 7C are exemplary photographs of 1:1 CNC/Ch-EL suspension before (7A) and after (7B) ultrasonic homogenization, and after stored for 14 days (7C), respectively.

FIGS. 8A and 8B are exemplary photographs of 1:1 CNC/Ch-EL films in accordance with certain non-limiting embodiments of the disclosed subject matter.

FIG. 9 is exemplary photographs of CNC/Ch films with high air flux and high degree of acetylation (DA) (9A), high air flux and medium DA (9B), and low air flux and medium DA (9C), respectively.

FIG. 10 is an exemplary of biodegradation study of 1:1 CNC/Ch-H blend film, prepared by using commercially obtained chitin nanofibers with DA similar to Ch-H.

FIG. 11 is comparison of OP (A) and N-WVTR (B) of 1:1 CNC/Ch-L/CA at various CA loadings. First bar of each sample is testing result at 23° C., 50% RH and second bar of each sample is testing result at 23° C., 80% RH for OP, 38° C., 80% RH for N-WVTR.

FIG. 12 is comparison of OP (A) and N-WVTR (B) of 1:1 CNC/Ch-EL/20% CA, 1:1 CNC/Ch-EL/30% CA, and 1:1 CNC/Ch-EL/30% CA-HT (“HT” denotes “thermally treated”) films. 1:1 CNC/Ch-EL and 1:1 CNC/Ch-L/30% CA films are listed as reference. First bar of each sample is testing result at 23° C., 50% RH and second bar of each sample is testing result at 23° C., 80% RH for OP, 38° C., 80% RH for N-WVTR.

FIG. 13 is comparison of 1:1 CNC/Ch-EL/30% CA and 1:1 CNC/Ch-EL/30% CA-HT with common packaging plastics (petroleum-based bioplastic:ethylene vinyl alcohol (EVOH), polyvinylidene chloride (PVDC), polyethylene terephthalate (PET), polystyrene (PS), high-density polyethylene (HDPE); bioplastics: CNC, chitosan, polylactic acid (PLA), cellulose acetate). Testing conditions: (13A) OP at 23° C., 50% RH (grey) or 80% RH (black). N-WVTR at 23° C., 50% RH. (13B) OP at 23° C., 50% RH. N-WVTR at 38° C., 80% RH.

FIG. 14 is comparison of mechanical properties, e.g., ultimate tensile strength (14A) and tensile strain break (14B) of common packaging plastics (EVOH, PET, PHB) with various CNC/Ch composites and CNC/Ch/CA composites in accordance with certain non-limiting embodiments of the disclosed subject matter.

FIG. 15 is comparison of OP (A) and N-WVTR (B) of various coatings on PLA substrate. First bar of each sample is testing result at 23° C., 50% RH. Second bar of each sample is testing result at 23° C., 80% RH for OP, 38° C., 80% RH for N-WVTR.

### DETAILED DESCRIPTION

The present disclosure relates to biodegradable composites for packaging and methods for producing such composites. For clarity and not by way of limitation, the detailed description of the presently disclosed subject matter is divided into the following subsections:
1. Definitions;
2. Renewable composites; and
3. Methods of making renewable composites.

### 1. Definitions

The terms used in this specification generally have their ordinary meanings in the art, within the context of this disclosure and in the specific context where each term is used. Certain terms are discussed below, or elsewhere in the specification, to provide additional guidance to the practitioner in describing the compositions and methods of the present disclosure and how to make and use them.

For purposes of interpreting this specification, the following definitions will apply and whenever appropriate, terms used in the singular will also include the plural and vice versa. In the event that any definition set forth below conflicts with any document incorporated herein by reference, the definition set forth below shall control.

As used in the specification and the appended claims, the singular forms “a,” “an” and “the” include plural referents unless the context clearly dictates otherwise. Thus, for example, reference to “a compound” includes mixtures of compounds. As another example, reference to “a composite” includes mixtures of composites.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The present disclosure also contemplates other embodiments “comprising,” “consisting of,” and “consisting essentially of,” the embodiments or elements presented herein, whether explicitly set forth or not.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction. Ranges disclosed herein, for example, “between about X and about Y” are, unless specified otherwise, inclusive of range limits about X and about Y as well as X and Y.

The terms “renewable composite”, “renewable plastic”, “biodegradable composite”, or “biodegradable plastic” are used interchangeably herein and refer to compositions made from renewable, biodegradable, biocompatible, and/or non-toxic materials.

The terms “composite” as used in accordance with the present disclosure refers to a material produced from two or more constituent materials with different physical and chemical properties.

The terms “barrier property” or “barrier performance” are used interchangeably herein and refers to oxygen permeability (OP), oxygen transmission rate (OTR), thickness normalized water vapor transmission rate (N-WVTR), and water vapor transmission rate (WVTR). In non-limiting embodiments, OP defines the ability that oxygen passes through a particular material and OTR is the measurement of the amount of oxygen gas that passes through a substance over a given period. In non-limiting embodiments, WVTR defines the rate at which the water vapor permeates through a solid material over a specific period of time and N-WVTR equals to the measured WVTR multiplied by the gauge of the sample in mils.

The terms “cross-link” or “crosslink” used interchangeably herein and refer to a bond or a short sequence of bonds that link one polymer chain to another. The bonds may include, but not limited to, covalent bonds, ionic bonds, electrostatic interactions, or hydrogen bonds. The cross-link reactions may be initiated by heat, pressure, change in pH, or irradiation. The terms “cross-linker”, “crosslinker”, or “crosslinking reagents” are used interchangeably herein and refer to the chemical used to promote the formation of the bonds that link the polymer chains.

The term “degree of acetylation” or “DA” as used in accordance with the present disclosure refers to the percentage of acetylation units with respect to the total number of units in polymer.

The terms “weight percent” or “wt. %” or “by weight” as used in accordance with the present disclosure refer to either (i) the quantity by weight of a constituent/component in a composition as a percentage of the total weight of the composition; or (ii) the quantity by weight of a constituent/component in the material as a percentage of the weight of the final material or product.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

### 2. Renewable Composites

Renewable composites of the present disclosure advantageously have low oxygen permeability (OP) and low thickness normalized water vapor transmission rate (N-WVTR) values, making them excellent candidates as packaging materials. In non-limiting embodiments, the renewable composites comprise cellulose nanocrystals (CNC) and chitin (Ch). In other non-limiting embodiments, the renewable composites comprise CNC, Ch, and one or more cross-linkers.

### 2.1 CNC/Ch Binary Composite

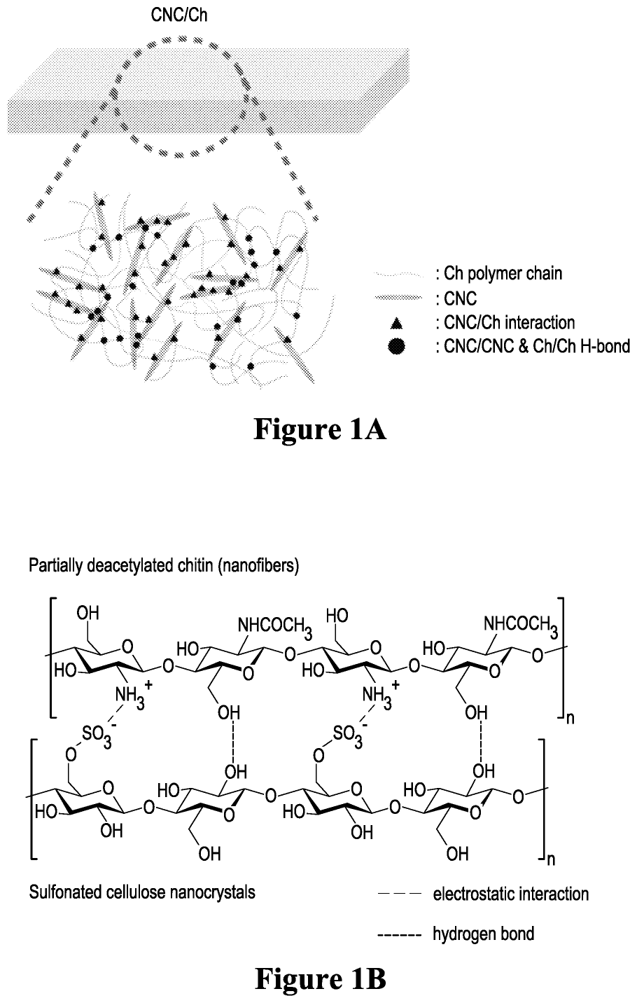

In certain embodiments, the disclosed subject matter provides CNC/Ch composites as biodegradable composites. FIG. 1A is exemplary illustrations of the structure of CNC/Ch composite film. In certain embodiments, CNC and Ch polymer chains may form a cross-linking network through CNC/Ch interactions. In non-limiting embodiments, as shown in FIG. 1B, electrostatic interaction, e.g., electrostatic attraction, is formed between the sulfone group on the CNC chain and amino group on the Ch chain. Furthermore, hydrogen bonds are formed between hydroxy groups on the CNC and Ch polymer chains. In certain embodiments, the hydrogen bonds can form between CNC and CNC chains, between CNC and Ch chains, and between Ch and Ch chains.

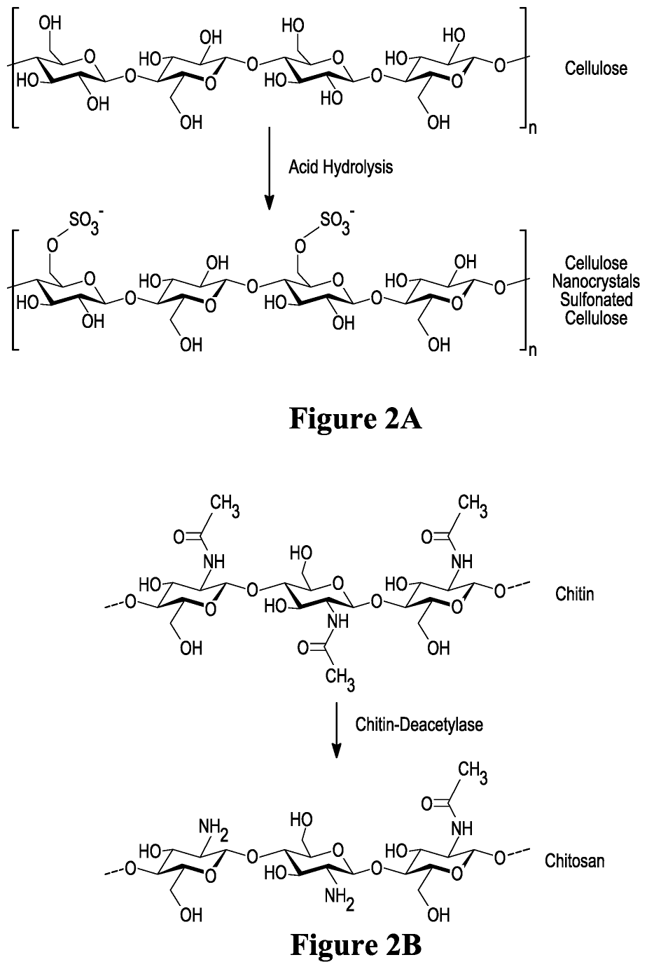

Cellulose is the basic component of plant cell walls. It has a hierarchical structure in the form of fibers (Habibi Y, Lucia LA, Rojas OJ. Cellulose nanocrystals: chemistry, self-assembly, and applications. Chemical reviews 2010, 110 (6), 3479-500). cellulose nanocrystal (CNC) represents the crystalline regions extracted from cellulose microcrystals. In non-limiting embodiments, CNC is extracted from cellulose by strong acid hydrolysis at elevated temperature. The crystalline nature of the CNC is primarily obtained from removing the amorphous segments from the naturally occurring cellulose fibers via strong acid hydrolysis. FIG. 2A illustrates polymer structures of cellulose and CNC, e.g., sulfonated cellulose. As shown in FIG. 2A, through acid hydrolysis, rod-like CNC can be extracted from cellulose fibers.

Chitin (Ch) is the second most abundant biopolymer on earth behind cellulose and is the most abundant biopolymer in the ocean. Chitin can be found naturally in alga, crustaceans, fungi, and insects (Barikani M, Oliaei E, Seddiqi H, Honarkar H. Preparation and application of chitin and its derivatives: a review. Iranian Polymer Journal 2014, 23 (4), 307-326). FIG. 2B illustrates polymer structures of chitin and chitosan. Chitin is a linear polymer with the repeating (1, 4)-β-N-acetylglucosamine units. Due to its insolubility in common solvents, the exploit of chitin applications remains limited. Instead, its deacetylated derivative, chitosan, are widely used as the hosts of biomedical applications including wound dressings, tissue engineering, and drug delivery (Duan B, Huang Y, Lu A, Zhang L. Recent advances in chitin based materials constructed via physical methods. Progress in Polymer Science 2018, 82, 1-33). During deacetylation process, the acetyl group (—C(═O)—CH₃) was replaced with the amino group (—NH₂), resulting in a co-polymer of N-acetylglucosamine and glucosamine (FIG. 2B). As the natural chitin has glucosamine units as well and the deacetylation is never complete, the degree of acetylation (DA) being the percentage of N-acetylglucosamine units with respect to the total number of units in the polymer is commonly used to describe the chemical and physical properties of chitin/chitosan. The DA of natural chitin is approximately 90% and the DA of chitosan is approximately 5˜15% (Jang M K, Kong B G, Jeong Y I, Lee C H, Nah J W. Physicochemical characterization of a-chitin, B-chitin, and y-chitin separated from natural resources. Journal of Polymer Science Part A: Polymer Chemistry 2004, 42 (14), 3423-3432). By adjusting the deacetylation conditions such as alkali concentration, reaction time, and chitin concentration, chitin with a controlled DA can be prepared. For example, samples Ch-H, Ch-M, Ch-L, and Ch-EL with various DAs are prepared, which will be discussed in further details below.

In certain embodiments, a weight ratio between the CNC and Ch is from about 1:0 to about 0:1. In particular embodiments of the composite, the weight ratio between the CNC and the Ch is from about 1:10 to about 10:1, from about 1:5 to about 5:1, from about 1:3 to about 3:1, or from about 1:2 to about 2:1. In some non-limiting embodiments, the weight ratio between the CNC and Ch is about 1:1.

In certain embodiments, the CNC/Ch composites comprise one or more fillers. In non-limiting embodiments, the one or more fillers are clay, talcum, or calcium carbonate. In certain embodiments, the one or more fillers are bentonite (BNT) clay. In certain embodiments, a weight ratio between the one or more fillers and a total weight of CNC and Ch is from about 1% to about 99%, from about 10% to about 90%, from about 20% to about 80%, from about 30% to about 70%, or from about 40% to about 60%.

### 2.2 CNC/Ch Ternary Composite

In certain non-limiting embodiments, the present disclosure provides CNC/Ch composites further including one or more cross-linkers. The usage of cross-linker may further improve the cross-linking structure of the CNC/Ch composite and thus improve the mechanical and barrier properties of the CNC/Ch composite.

In certain embodiments, the cross-linker can be any chemical containing >1 functional chemical groups capable of forming a covalent bond between two or more adjacent polymer chains. Examples of functional groups include but are not limited to, alcohols, amines, aldehydes, ketones, sulfhydryls, isocyanates, thiol, thiol-chloride, acid chloride, other suitable organic acid. In non-limiting embodiments, the cross-linker can be any other suitable carboxylic acid containing one or more carboxyl groups. In certain embodiments, the cross-linker can be any other suitable di-functional carboxylic acids which contain two carboxyl groups. In non-limiting examples, citric acid, malic acid, succinic acid, or adipic acid can be used as cross-linker. In other non-limiting examples, oxalic acid, malonic acid, glutaric acid, pimelic acid, suberic acid, azelaic acid, sebacic acid, undecanedioic acid, dodecanedioic acid, brassylic acid, thapsic acid, japanic acid, phellogenic acid, or equisetolic acid can be used as cross-linker. In certain embodiments, any tri-functional carboxylic acids which contain three carboxyl groups can be used as the cross-linker. In non-limiting examples, isocitric acid, aconitic acid, propane-1,2,3-tricarboxylic acid, dicarboxylic acid, agaric acid, trimesic acid can act as cross-linker. In certain embodiments, the cross-linker can be a mixture of one or more organic acids.

In certain embodiments, the cross-linking may result from the formation of a covalent bond via the generation of radicals using radical initiators (examples include but are not limited to halogens, azo compounds, organic peroxides, transition metals), exposure to UV irradiation, gamma irradiation, or heat.

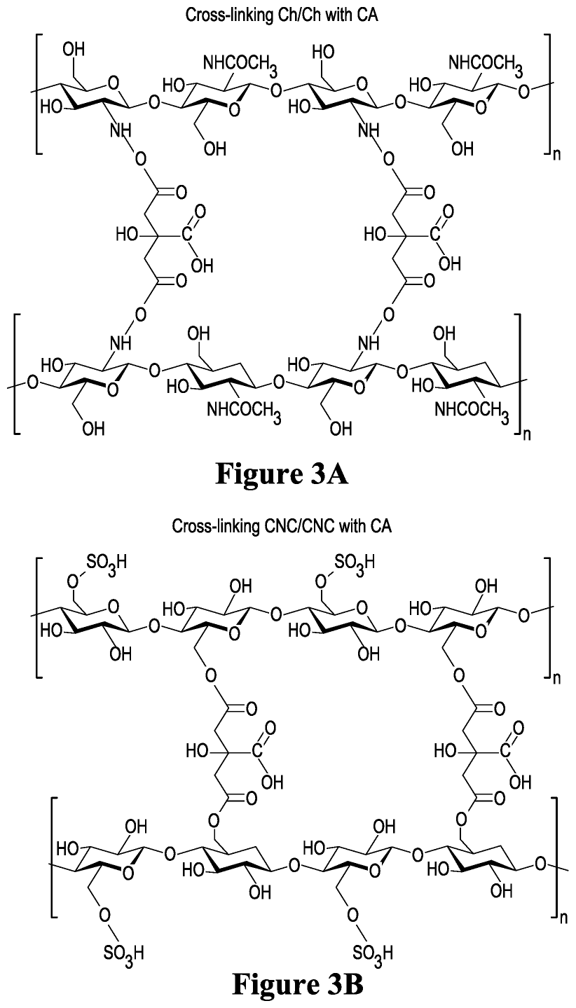

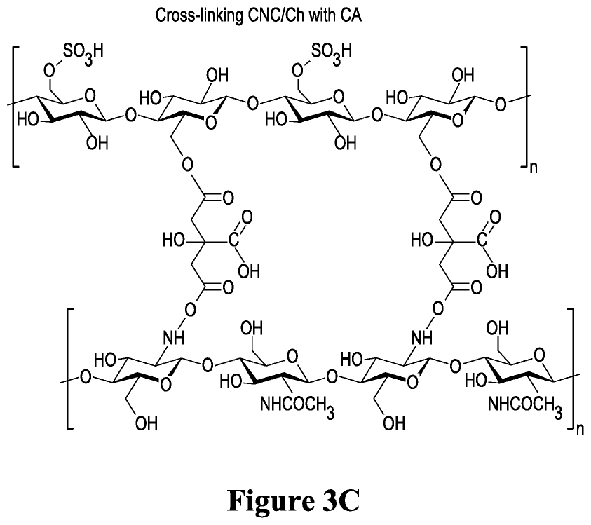

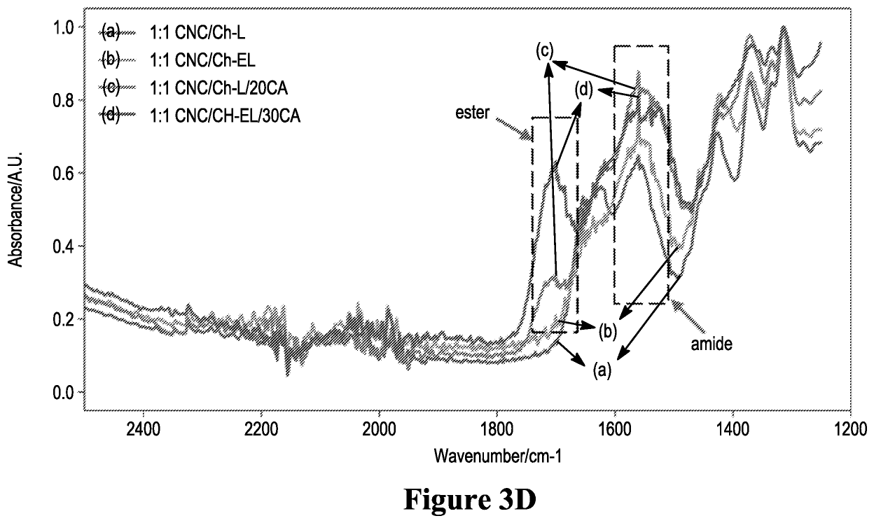

As an example, citric acid (CA) may be used as the cross-linker for the CNC/Ch composite. FIGS. 3A-3C are exemplary illustrations of the cross-linking structure in CNC/Ch/CA composite. There may be three cross-linking mechanisms between CA and the CNC/Ch polymer chains. In non-limiting embodiments, CA may cross-link Ch and Ch chains through amide bond (FIG. 3A). In certain embodiments, CA may cross-link CNC and CNC chains through ester bond (FIG. 3B). In certain embodiments, CA may cross-link CNC and Ch chains through the formation of amide bonds and ester bonds simultaneously (FIG. 3C). In other embodiments, the CNC and Ch chains in CNC/Ch/CA composite may also cross-link with one another through electrostatic interaction and hydrogen bonds as illustrated in FIG. 1B above. In certain embodiments, the weight ratio between the CA and a total weight of CNC and Ch is from about 5:95 to about 95:5.

The cross-linking of CA with CNC and Ch may be confirmed from Fourier-transform infrared (FT-IR) spectra. FIG. 3D shows the FT-IR spectra of 1:1 CNC/Ch-L (CNC/Ch-L composite with weight ratio between CNC and Ch-L being 1:1), 1:1 CNC/Ch-EL (CNC/Ch-EL composite with weight ratio between CNC and Ch-EL being 1:1), 1:1 CNC/Ch-L/20% CA (CNC/Ch-L/CA composite with CA being 20 wt. % of a total weight CNC and Ch-L), and 1:1 CNC/Ch-EL/30% CA (CNC/Ch-EL/CA composite with CA being 30 wt. % of a total weight CNC and Ch-EL).

As shown in FIG. 3D, the peak located around 1550 cm⁻¹ is assigned to the N—H bending of amide bond, and the characteristic peak of ester C═O stretching emerges around 1740 cm⁻¹. For 1:1 CNC/Ch-L sample and 1:1 CNC/Ch-EL sample, no ester peak is observed. The ester peak emerges in CNC/Ch/CA and the peak intensity increases as the CA loading increases, e.g., in 1:1 CNC/Ch-EL/30CA sample. The amide peak is present in all spectra as being part of the acetylamino group in Ch. The intensity of amide peak is stronger in CNC/Ch/CA ternary film than the CNC/Ch binary film due to the Ch/CA amide crosslinks. These observations confirm the existence of CA cross-linking CNC/Ch chains.

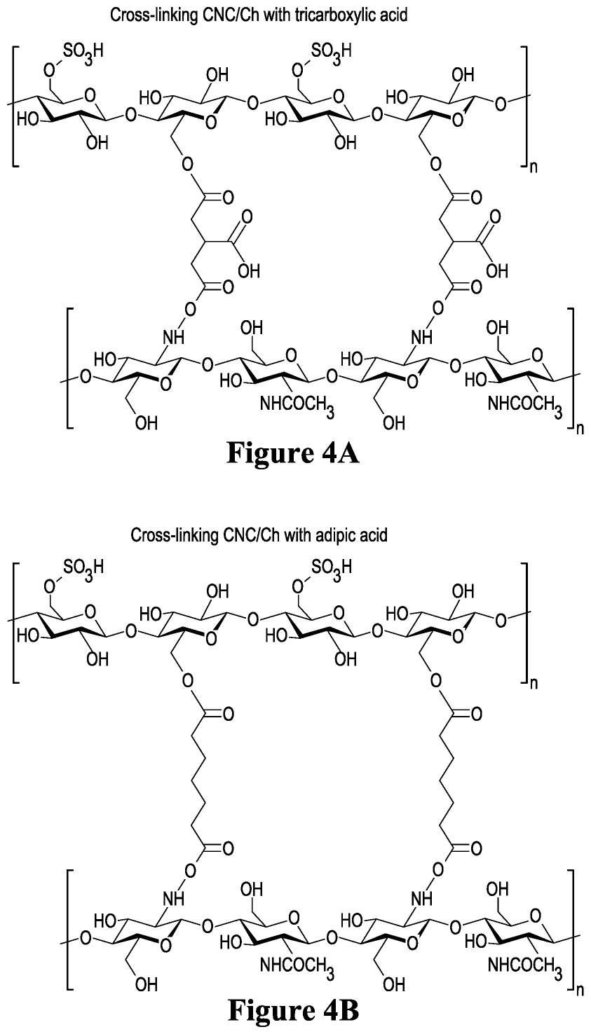

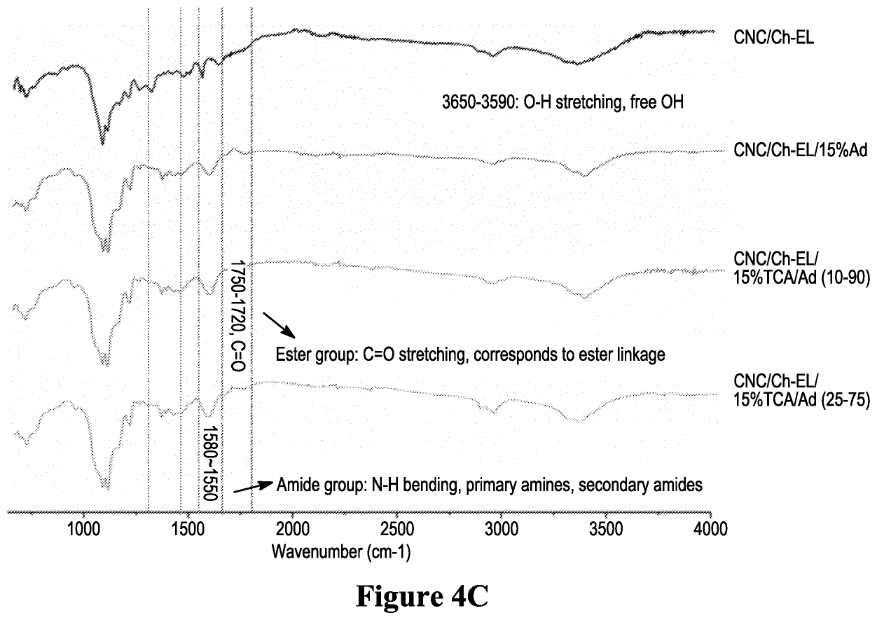

As another example, propane-1,2,3,-tricarboxylic acid (TCA) and/or adipic acid (Ad) may be used as the cross-linkers for the CNC/Ch composite. FIG. 4A is an exemplary illustration of the TCA as the cross-linker to link CNC with Ch polymer chains. Similar to CNC/Ch/CA cross-linking structure shown in FIG. 3C above, TCA may link CNC and Ch polymer chains through the formation of amide and ester bonds. In addition, similar to CNC/Ch/CA composite, TCA may also link CNC with CNC chains through the formation of ester bonds and link Ch and Ch chains through the formation of amide bonds (not shown). In addition, the CNC and Ch polymer chains in the CNC/Ch/TCA composite may also link with one another through electrostatic interaction and hydrogen bonds as illustrated in FIG. 1B above.

FIG. 4B is an exemplary illustration of the adipic acid (Ad) as the cross-linker to link CNC with Ch polymer chains. Similar to CNC/Ch/CA and CNC/Ch/TCA cross-linking structures shown in FIGS. 3C and 4A, Ad may link CNC and Ch polymer chains through the formation of amide and ester bonds. In addition, similar to CNC/Ch/CA and CNC/Ch/TCA composites, Ad may also link CNC with CNC chains through the formation of ester bonds and link Ch and Ch chains through amide bonds (not shown). In addition, the CNC and Ch polymer chains in the CNC/Ch/Ad composite may also link with one another through electrostatic interaction and hydrogen bonds as illustrated in FIG. 1B above.

The cross-linking of TCA and Ad with CNC and Ch can be confirmed from FT-IR spectra. FIG. 4C shows the FT-IR spectra of 1:1 CNC/Ch-EL, 1:1 CNC/Ch-EL/15% Ad (CNC/Ch-EL/Ad composite with weight ratio between CNC and Ch-El being 1:1 and Ad being 15 wt. % of a total weight CNC and Ch-EL), 1:1 CNC/Ch-EL/15% TCA-Ad (10-90) (CNC/Ch-EL/TCA-Ad composite with a mixture of TCA and Ad being 15 wt. % of a total weight of CNC and Ch-EL and the weight ratio between TCA and Ad being 10:90); and 1:1 CNC/Ch-EL/15% TCA-Ad (25-75).

As shown in FIG. 4C, the peak located around 1550-1580 cm⁻¹ is assigned to the N—H bending of amide bond, and the characteristic peak of ester C═O stretching emerges around 1720-1750 cm⁻¹. For 1:1 CNC/Ch-EL sample, no ester peak is observed. The ester peak appears in 1;1 CNC/Ch/15% Ad, 1:1 CNC/Ch-EL/15% TCA-Ad (10-90), and 1:1 CNC/Ch-EL/15% TCA-Ad (25-75) samples, indicating the formation of ester bonds between the cross-linkers, e.g., Ad and/or TCA, and CNC polymer chains. The amide peak is present in all spectra as being part of the acetylamino group in Ch. The intensity of amide peak is stronger in CNC/Ch/Ad or CNC/Ch-EL/TCA-Ad composites than the CNC/Ch-EL composites due to the formation of amide bonds between the cross-linkers and Ch polymer chains.

### 3. Methods of Making Renewable Composites

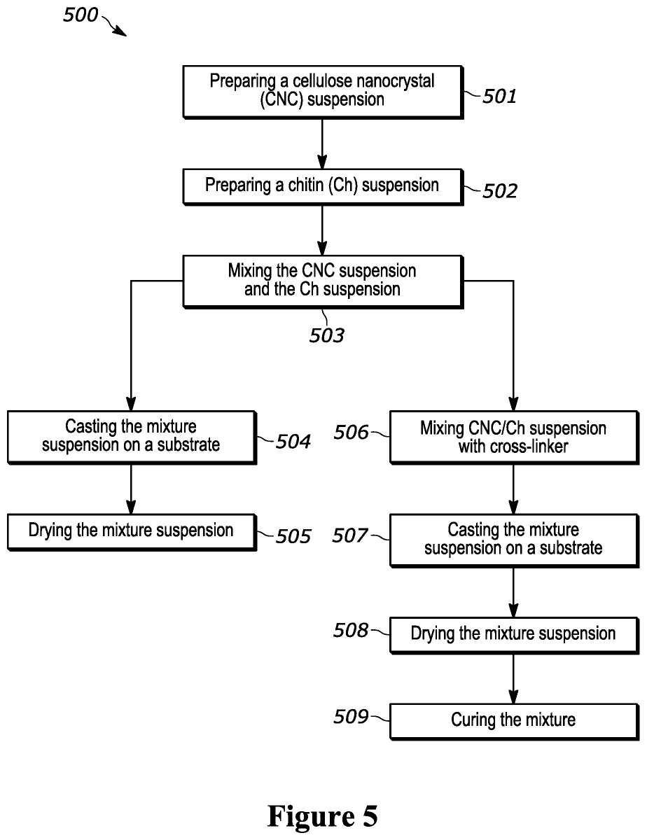

In certain embodiments, a method of producing renewable composites is provided. A variety of processes can be used to provide the renewable composites of the present disclosure. An exemplary method for making a renewable composite of the present disclosure is shown in FIG. 5.

At step 501, a cellulose nanocrystal (CNC) suspension may be prepared. A variety of processes and a variety of solvents can be used to prepare the CNC suspension, including water or mixtures of water and alcohols like methanol, ethanol or isopropanol. Suspensions can be prepared by diluting concentrated CNC suspensions, or by resuspending freeze dried or spray dried CNCs. Agitation for suspending CNCs can be provided by homogenization, ultrasound, or stirring with an motor-driven impeller or magnetic stir bar. In one non-limiting embodiment, the CNC suspension is an aqueous suspension. In certain embodiments, the pH value of the prepared CNC aqueous suspension is from about 5 to about 7 or from about 5 to about 6. In a more specific example, the pH value of the prepared CNC aqueous suspension is about 5.6. In some embodiments, the concentration of the CNC aqueous suspension is about 10 wt. %. In other embodiments, the concentration of the CNC aqueous suspension is about 5 wt. %, 3 wt. %, 2 wt. %, 1 wt. %, or 0.5 wt. %.

At step 502, a chitin (Ch) liquid mixture may be prepared. In some embodiments, deacetylated Ch powder may first be prepared by refluxing the as-received chitin powder in a boiling NaOH solution heated by an oil bath. The degree of acetylation (DA) may be controlled by adjusting the NaOH concentration and the deacetylation time. The deacetylated chitin may be washed by deionized water to PH neutral and dried before use.

Next, a chitin liquid mixture may be prepared using the deacetylated Ch powder prepared above. A variety of processes and a variety of solvents can be used to prepare the Ch suspension. Depending on the DA of the Ch powder and/or the type of solvents used, the Ch liquid mixture may be a Ch solution or a Ch suspension. For example, Ch powder with relatively low DA, e.g., Ch-EL, is soluble in acetic acid solution. On the other hand, Ch powder with relatively high DA, e.g., Ch-H and Ch-M is not soluble while Ch-L is partially soluble. Solvents can include aqueous solutions containing acids like acetic acid, citric acid, or lactic acid, as well as solutions of water and alcohols like methanol, ethanol or isopropanol. In one non-limiting embodiment, the Ch powder is dispersed in aqueous solution of acetic acid. In certain embodiments, the pH value of the prepared Ch liquid mixture is from about 3 to about 5 or from about 3 to about 4. In a more specific example, the pH value of the prepared Ch liquid mixture is about 3. In some embodiments, the concentration of the Ch liquid mixture is about 10 wt. %. In other embodiments, the concentration of the Ch liquid mixture is about 5 wt. %, 3 wt. %, 2 wt. %, 1 wt. %, or 0.5 wt. %.

At step 503, the CNC suspension prepared at step 501 and the Ch liquid mixture prepared at step 502 may be mixed to form a mixture suspension. Any suitable methods may be used to mix the CNC suspension and Ch liquid mixture, including homogenization, ultrasound, a motorized impeller or magnetic stir bar. For example, the CNC suspension and Ch liquid mixture may be mixed by a magnetic stirrer. In a more specific example, the CNC suspension and Ch liquid mixture may be mixed by a magnetic stirrer at 500 rpm for 4 hrs. In non-limiting embodiments, the CNC/Ch mixture suspension may be denoted as x:y CNC/Ch, where x:y is the weight ratio of CNC and Ch. In certain embodiment, the weight ratio between the CNC and Ch in the mixture suspension is from about 1:10 to about 10:1, from about 1:5 to about 5:1, from about 1:3 to about 3:1, or from about 1:2 to about 2:1. In one specific example, the weight ratio between the CNC and Ch in the mixture suspension is about 1:1. In some embodiment, the pH value of the CNC and Ch mixture suspension is from about 3 to 4. In certain embodiments, the resultant CNC/Ch mixture suspension may be degassed in an ultrasonic bath. In some embodiments, additional solvents may be added in the CNC/Ch mixture suspension to improve the stability of the suspension. For example, isopropyl alcohol (IPA) may be added in the CNC/Ch suspension.

Next, at step 504, the CNC/Ch mixture suspension may be coated on a substrate, e.g., PS petri dish or a biodegradable substrate, such as a polylactic acid (PLA). In non-limiting embodiments, the CNC/Ch composite film may be coated on a substrate by any suitable methods. As an example, the CNC/Ch composite film can be coated on a substrate by blade coating, spin coating, dip coating, or bar coating. In certain embodiments, the CNC/Ch suspension can be coated on a substrate for one or more times. For example, the CNC/Ch suspension can be coated on a PLA substrate by blade coating for three times. As another example, the CNC/Ch suspension can be coated on PLA substrate by blade coating for six times. In other embodiments, there is no upper limit of the number of times that a substrate can be coated with CNC/Ch composite films. In certain embodiments, each coating can be followed with about 10 seconds to 30 minutes of drying time for form a semi-dry film before forming next coating layer. In other embodiments, each coating can be followed with about 2 minutes to 30 minutes of drying time for form a relatively dry film before forming next coating layer.

Next, at step 505, the cast CNC/Ch film at step 504 may be dried. In certain embodiments, the CNC/Ch film may be air-dried. In some embodiments, the CNC/Ch film may be air-dried in a fume hood at room temperature. In some embodiments, the drying time is about 1 to 12 days, from about 1 to 5 days, or about 2 days.

In some other embodiments, CNC/Ch ternary composite with one or more cross-linkers may be prepared through step 506 to step 509. For example, at step 506, CNC/Ch mixture suspension may be mixed with one or more cross-linkers. In certain embodiments, the one or more cross-linkers may be added into the CNC/Ch suspension. As an example, CA powder at various amounts (10 wt. %, 15 wt. %, 20 wt. %, 30 wt. %, 50 wt. %, and 100 wt. %, with respect to the total weight of CNC/Ch) may be added in the CNC/Ch suspension. As another example, propane-1,2,3,-tricarboxylic acid (TCA) and/or adipic acid (Ad) at various amounts (10 wt. %, 15 wt. %, 20 wt. %, 30 wt. %, 50 wt. %, and 100 wt. %, with respect to the total weight of CNC/Ch) may be added in the CNC/Ch suspension. In other embodiments, a solution containing one or more cross-linkers may be prepared and then mixed with the CNC/Ch suspension. Various methods may be used to mix the cross-linkers with the CNC/Ch suspension, including homogenization, ultrasound, a motorized impeller or magnetic stir bar. For example, the cross-linkers and the CNC/Ch suspension may be mixed by a magnetic stirrer. The resultant mixture may be degassed in an ultrasonic bath. In one example, the resultant mixture may be degassed in an ultrasonic bath for 3 to 5 min.

Next, at step 507, the CNC/Ch/cross-linker mixture suspension may be coated on a substrate, e.g., PS petri dish or a PLA substrate, similar to the process discussed in step 504 above. At step 508, CNC/Ch/cross-linker mixture film may be dried similar to the process discussed in step 505 above.

Next, at step 509, the CNC/Ch/cross-linker film obtained at step 508 may be heated to initiate the cross-linking reactions between the one or more cross-linkers and CNC/Ch chains. In certain embodiments, the CNC/Ch/cross-linker film may be heated in a convection oven at atmospheric pressure for an extended period of time. In one example, the CNC/Ch/cross-linker film may be heated in a convection oven overnight. The temperature may depend on the type of cross-linkers used. In one embodiment, the CNC/Ch/cross-linker film may be heated in the convection oven at a temperature from about 50° C. to about 200° C. As an example, the CNC/Ch/cross-linker films may be heated in the convection oven at 60° C. or 100° C. for 3 hrs. After thermal treatment, the film may be naturally cool down to room temperature.

### 4. Examples

The presently disclosed subject matter provides renewable composites with low oxygen permeability and water vapor transmission rate values, thus making these composites excellent candidates for packaging materials. The below examples are exemplary only and should in no way be taken as limiting.

### Example 1—CNC/Ch Composite

A serious of CNC/Ch composites with different degree of acetylation (DA) of Ch were prepared. To prepare Ch samples with different degree of DA, e.g., Ch-H sample, Ch-M sample, Ch-L sample, and Ch-EL sample, the chitin powder was treated in 5 wt. % NaOH solution for 24 hours, 35 wt. % NaOH solution for 2.5 hours, 35 wt. % NaOH solution for 5 hours, and 40 wt. % NaOH solution for 7 hours, respectively. The deacetylated chitin was then washed by deionized water to PH neutral and dried in an oven at 60° C. overnight.

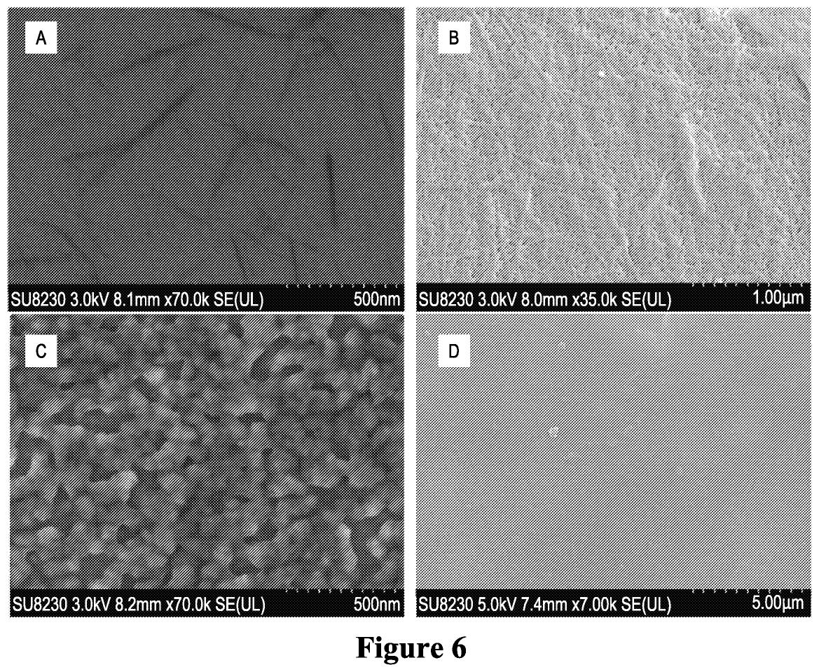

FIG. 6 shows the SEM images of Ch-H (FIGS. 6A and 6B) and Ch-EL (FIGS. 6C and 6D) coatings/films. FIGS. 6A and 6C are Ch-H and Ch-EL coating, respectively, heat-dried from 10 uL of 0.001 wt. % Ch liquid mixture on Si wafer. FIGS. 6B and 6D are self-standing Ch-H and Ch-EL film, respectively, cast from 25 mL of 0.5 wt. % Ch liquid mixture on PS petri dish. In certain embodiments, the Ch-H liquid mixture is a Ch-H suspension, and the Ch-EL liquid mixture is a Ch-EL solution.

FIGS. 6A and 6B reveal the nanofibrous morphology of Ch-H (ChNFs). ChNFs are extracted from bundles of microfibrillar chitin during the high-pressure homogenization process. FIG. 6D shows a homogenous film morphology demonstrating the nanofibrous morphology no longer exists in Ch with low DA, e.g., Ch-EL. Instead, the Ch powder transits directly from microfibrillar form to soluble chitin after harsh deacetylation reaction and high-pressure homogenization. This observation is more evident for Ch-EL as the Ch-EL powder after deacetylation is soluble in acetic acid solution without homogenization. FIG. 6C shows the SEM image of a loose Ch-EL coating heat-dried from 10 uL of 0.001 wt. % Ch-EL solution on Si wafer. Unlike Ch-H which shows individual nanofibers (FIGS. 6A and 6B), a uniform porous morphology is observed as soluble chitin grows into merged particles. Soluble chitin can greatly expand the application of chitin due to its ease of processing and high compatibility.

Next, 5 g of dried chitin powder with different DA was introduced into 1 L acetic acid at pH 3 and then high pressure homogenized in a homogenizer (Mini DeBEE Homogenizer, South Easton, MA). The sequence settings are 20 passes at 1034 bar, followed by 10 additional passes at 1516 bar. The resulting 0.5 wt. % chitin liquid mixture, Ch solution (Ch-EL) or suspension (Ch-H, Ch-M, Ch-L). was transparent and homogenous.

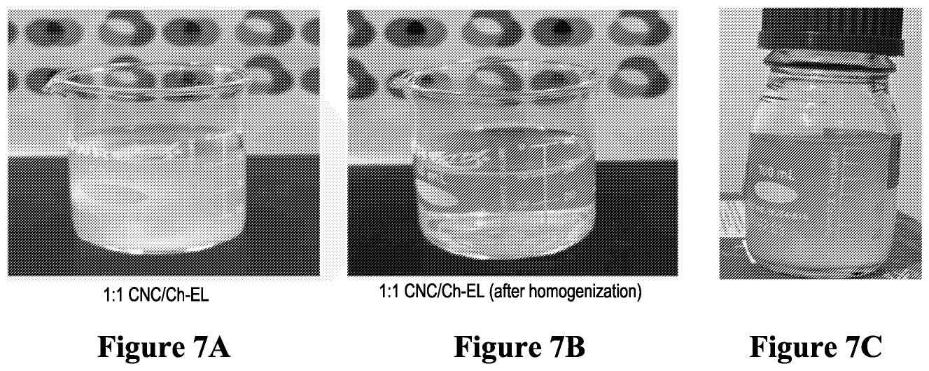

CNC/Ch blend film was prepared by solution casting method. 0.5 wt. % CNC aqueous suspension and 0.5 wt. % Ch solution (Ch-EL) or suspension (Ch-H, Ch-M, Ch-L) at various CNC: Ch blend ratios (1:0, 3:1, 1:1, 1:3, 0:1) were mixed by a magnetic stirrer at 500 rpm for 3 to 4 hrs. The resultant mixture was treated in an ultrasonic bath for a few minutes. As shown in FIGS. 7A and 7B, the 1:1 CNC/Ch-EL suspension changed from opaque (FIG. 7A) to transparent (FIG. 7B) after ultrasonic homogenization, indicating a stable suspension was obtained after ultrasonic homogenization. Moreover, as shown in FIGS. 7C, the 1:1 CNC/Ch-EL suspension was stable after stored for 14 days.

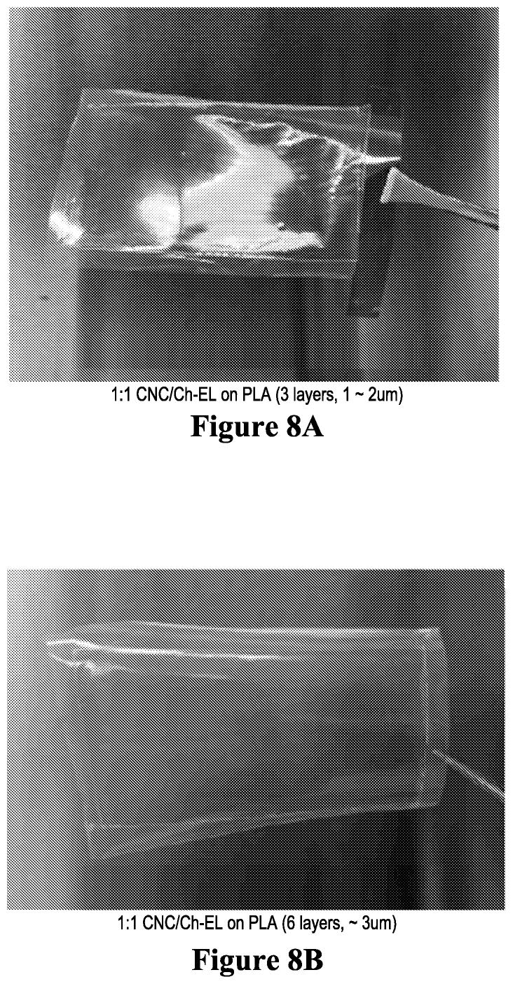

Next, the CNC/Ch mixture suspension was cast on a substrate, e.g., PS petri dish or a PLA substrate by blade coating. The CNC/Ch suspension was coated on a PLA substrate by blade coating for three times or six times. The thickness of the CNC/Ch film was about 1-2 μm when coated three times (FIG. 8A) and was about 3 μm when coated six times (FIG. 8B).

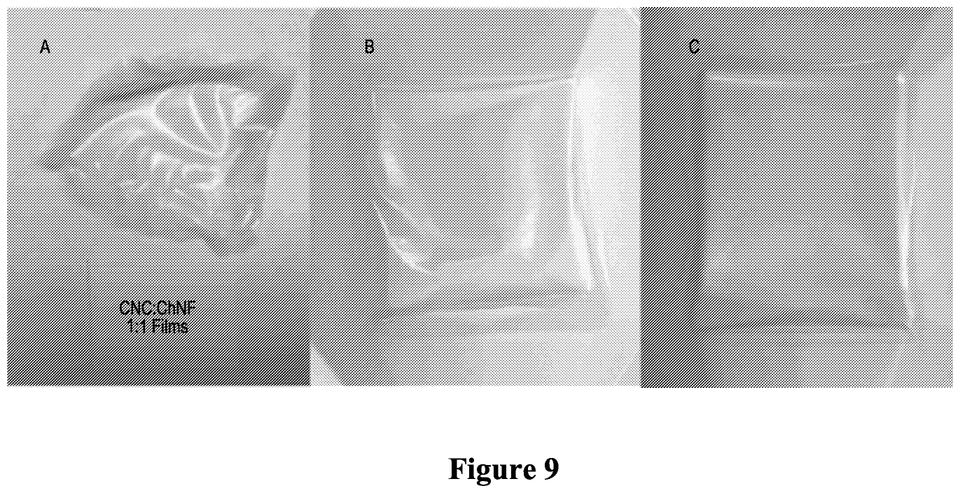

Lastly, the CNC/Ch suspension was air-dried in a fume hood for 2 days. Air flux used to air-dry the CNC/Ch blends and DA of Ch have great impact on the film-forming properties of CNC/Ch blends. FIG. 9 is exemplary photographs of CNC/Ch films with (A) high air flux and high DA; (B) high air flux and medium DA; and (C) low air flux and medium DA. When DA or air flux was high, the cast CNC/Ch blend film was lightly distorted (FIG. 9B) to highly distorted (FIG. 9A). As shown in FIG. 9C, with low air flux and medium DA, a plat and smooth film was formed. In addition to air flux and DA, low loading of Ch (less than 25 wt. %) can also lead to lightly distorted film. Highly distorted films are very difficult to laminate which makes the films impractical to use. With the findings, flat CNC/Ch blend films without noticeable distortion can be consistently prepared. The obtained CNC/Ch composite films were denoted as x:y CNC/Ch, where x:y is the weight ratio between CNC and Ch.

The oxygen barrier property of the samples was obtained by Labthink C230 instrument (Labthink International, MA) and MOCON OXTRAN 1/50 instrument (AMETEK MOCON, MN) at 23° C., 50% RH and 23° C., 80% RH. The water vapor barrier property of the film was obtained by MOCON PERMATRAN-W 1/50 G instrument (AMETEK MOCON, MN) at 23° C., 50% RH and 37.8° C., 80% RH unless otherwise specified. Prior to the barrier test, the film was conditioned at 53% RH, 23° C. for at least 2 days. In general, in order to achieve accurate oxygen and water vapor barrier property measurements, film samples were masked with self-adhesive aluminum foils bearing a circular hole in the center secured on both sides of the sample film. Film thickness was measured by a micrometer (1 μm resolution) at more than 6 different points. Zeta potentials were collected on a Zetasizer Nano ZS (Malvern Panalytical, United Kingdom). SEM images and EDS elemental mappings were taken on a Hitachi SU-8230 SEM (Hitachi, Japan). Samples were sputter coated with gold prior to imaging. FT-IR spectra were collected by a Nicolet 6700 FT-IR spectrometer (Thermo Electron, MA). Spectra were normalized by the maximum intensity. Aerobic biodegradation of CNC/Ch films in soil was carried out following the ASTM D5988-18 standard procedure. Soil contains 4.52 wt. % carbon and 0.27 wt. % nitrogen.

Table 1 summaries some physical and chemical properties of the CNC and Ch suspensions, and the Ch-EL solution, e.g., 0.5 wt. % CNC suspension and 0.5 wt. % Ch. The absolute zeta potentials being over 40 mV for all Ch suspension and solution samples indicate that the Ch suspension and solution samples were cationic, which is required for the stable blending with anionic CNC suspensions, thus demonstrating good to excellent colloid dispersion stability.

TABLE 1
Physical and chemical properties of the CNC and Ch

| | | Degree of | Zeta Potential |
|---|---|---|---|
| Suspension | Form | Acetylation (%) | (mV) |
| CNC | nanocrystal | / | −42.2 |
| Ch-H | chitin nanofiber | 91.7 ± 2.3 | +43.9 |
| Ch-M | chitin nanofiber | 77.3 ± 6.3 | +62.9 |
| Ch-L | chitin nanofiber + | 70.7 ± 0.3 | +60-65 |
| | soluble chitin | | |
| Ch-EL | soluble chitin | 67.1 ± 0.3 | +63-75 |

The oxygen permeability of CNC/Ch films at various DAs and blend ratios are shown in Table 2. The DA of chitin plays a significant role on oxygen barrier properties. At 23° C., 50% relative humidity (RH), the lower the DA, the better the oxygen barrier properties. For example, the CNC/Ch-EL samples show the lowest oxygen permeability (OP) values in all three blending ratios (3:1, 1:1, 1:3) at 0.51, 0.45, and 0.48 cm³ μm m⁻² d⁻¹ kPa⁻¹, respectively, while CNC/Ch-H samples show the highest OP values in all three blending ratios at 3.8, 2.1, and 3.9 cm³ μm m⁻² d⁻¹ kPa⁻¹, respectively. In addition, CNC/Ch-El samples show lower OP values than CNC/chitosan samples in all three blending ratios. This trend is also observed for OP at 23° C., 80% RH, though the difference between CNC/Ch-M and CNC/Ch-L is relatively small. The effect of blend ratio is also evident as the OP of blend films are lower than neat CNC or neat Ch films. Among all CNC/Ch films, the average OPs for 1:0, 3:1, 1:1, 1:3, 0:1 blending ratios are 5.00, 1.55, 0.98, 1.44, 4.18 cm³ μm m⁻² d⁻¹ kPa⁻¹, respectively. Neat Ch-M and Ch-L films have similar oxygen barrier properties as the counterpart 1:3 blend films. The 1:1 blend films have the optimal oxygen barrier properties, despite the DA of the chitin. The 1:1 CNC/Ch-EL film has the best oxygen barrier property at 0.45 cm³ μm m⁻² d⁻¹ kPa⁻¹. This observation confirms the synergistic effect between CNC and Ch. For OP at 23° C., 80% RH, the effect of blend ratio plays a lesser important effect. Excluding the CNC/Ch-H films, the 1:1 CNC/Ch film and neat Ch films have shown superior oxygen barrier properties than other blend ratios with 3:1 blend ratio being the worst. Comparing the OP at 50% RH, the OP value at 80% RH is about 5 to 50 times higher with the best performance being neat Ch-EL and 1:1 CNC/Ch-EL at 19 and 20 cm³ μm m⁻² d⁻¹ kPa⁻¹, respectively.

TABLE 2
oxygen permeability (OP) of CNC/Ch blend films at various DAs and blend ratios.
Testing conditions: 23° C., 50% relative humidity (RH), and 23° C., 80% RH.

| | CNC | 3:1 CNC/Ch | 1:1 CNC/Ch | 1:3 CNC/Ch | Ch |
|---|---|---|---|---|---|
| Chitosan @ 50% RH | 5.0 | 0.89 | 0.72 | 2.0 | 1.1 |
| Ch-EL @ 50% RH | 5.0 | 0.51 | 0.45 | 0.48 | 1.8 |
| Ch-L @ 50% RH | 5.0 | 0.78 | 0.57 | 0.62 | 0.66 |
| Ch-M @ 50% RH | 5.0 | 1.1 | 0.82 | 0.76 | 0.76 |
| Ch-H @ 50% RH | 5.0 | 3.8 | 2.1 | 3.9 | 14.0 |
| Chitosan @ 80% RH | 27.0 | 41.0 | 30.0 | 33.0 | 36.0 |
| Ch-EL @ 80% RH | 27.0 | 21.0 | 20.0 | 24.0 | 19.0 |
| Ch-L @ 80% RH | 27.0 | 56.0 | 26.0 | 28.0 | 22.0 |
| Ch-M @ 80% RH | 27.0 | 31.0 | 22.0 | 26.0 | 25.0 |
| Ch-H @ 80% RH | 27.0 | 63.0 | 64.0 | 78.0 | 100.0 |

The water vapor barrier properties of CNC/Ch films at various DAs and blend ratios are shown in Table 3. Similar trends on the OP study are observed in thickness normalized water vapor transmission rate (N-WVTR) study as well: films prepared from lower DA at 1:1 blend ratio outperform films prepared from higher DA at other blend ratios. For example, the CNC/Ch-EL samples show the lowest N-WVTR values in all three blending ratios (3:1, 1:1, 1:3) at 5.2, 3.2, and 3.9 g mm m⁻² d⁻¹, respectively, while CNC/Ch-H samples show the highest N-WVTR values in all three blending ratios at 18.0, 14.0, and 20.0 g mm m⁻² d⁻¹, respectively. In addition, CNC/Ch-EL samples show lower N-WVTR values than CNC/chitosan samples in all three blending ratios. In terms of blend ratios, among all CNC/Ch films, the average N-WVTRs for 1:0, 3:1, 1:1, 1:3, 0:1 are 13, 10, 8.6, 9.2, and 9.8 g mm m⁻² d⁻¹, respectively. For CNC/Ch films with medium to low DA, the difference of N-WVTR among three blend ratio is relatively narrow, demonstrating that the overall effect of blend ratio is less evident than the effect of DA. This trend is also observed for N-WVTR at 38° C., 80% RH. Like other bio-sourced plastics, the barrier performance suffers a 7 to 15 times decline at higher temperature, higher humidity. This is because when the surrounding environment changes from a lower relative humidity to a higher relative humidity, cellulose and chitin slowly absorb moisture until they reach the equilibrium moisture content (EMC). This is ascribed to their rich hydrophilic sites and relatively high void fraction. The presence of moisture softens the film and increases the void fraction which affiliates the oxygen and water vapor to permeate through the film. High temperature amplified this effect due to the increased vapor pressure and diffusion rate.

TABLE 3
Thickness normalized water vapor transmission rate (N-WVTR)
of CNC/Ch blend films at various DAs and blend ratios. Testing
conditions: 23° C., 50% RH, and 38 ° C., 80% RH.

| | CNC | 3:1 CNC/Ch | 1:1 CNC/Ch | 1:3 CNC/Ch | Ch |
|---|---|---|---|---|---|
| Chitosan @ 23° C. 50% RH | 13.0 | 6.7 | 5.5 | 7.8 | 9.8 |
| Ch-EL @ 23° C. 50% RH | 13.0 | 5.2 | 3.2 | 3.9 | 4.1 |
| Ch-L @ 23° C. 50% RH | 13.0 | 7.7 | 4.3 | 4.8 | 7.8 |
| Ch-M @ 23° C. 50% RH | 13.0 | 10.0 | 5.2 | 8.0 | 6.6 |
| Ch-H @ 23° C. 50% RH | 13.0 | 18.0 | 14.0 | 20.0 | 23.0 |
| Chitosan @ 38° C. 80% RH | 130.0 | 79.0 | 96.0 | 120.0 | 130.0 |
| Ch-EL @ 38° C. 80% RH | 130.0 | 55.0 | 46.0 | 49.0 | 51.0 |
| Ch-L @ 38° C. 80% RH | 130.0 | 77.0 | 59.0 | 82.0 | 78.0 |
| Ch-M @ 38° C. 80% RH | 130.0 | 100.0 | 80.0 | 80.0 | 66.0 |
| Ch-H @ 38° C. 80% RH | 130.0 | 150.0 | 95.0 | 130.0 | 160.0 |

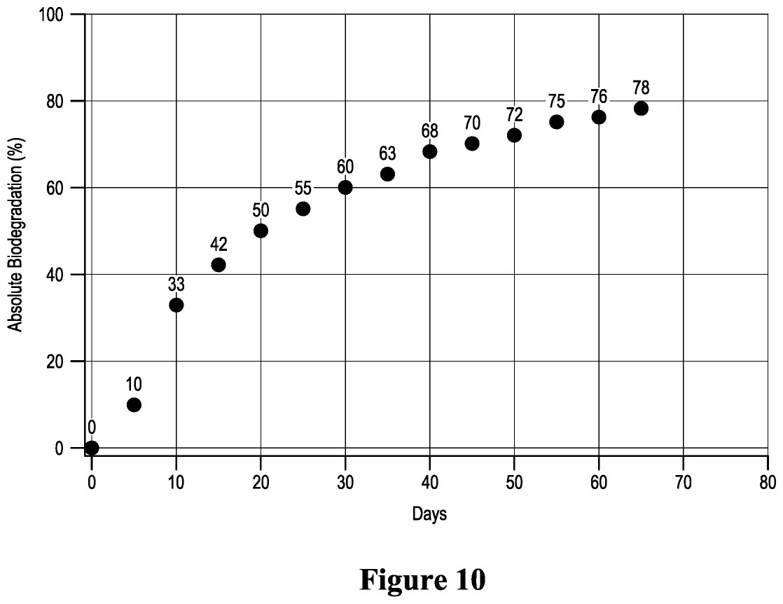

The biodegradation of CNC/Ch-H films in an aerobic environment is shown in FIG. 10, where the Ch-H sample was commercially obtained high-DA chitin nanofiber (Sugino, Inc.). For a short period of 65 days, the 1:1 CNC/Ch-H films were completely disintegrated and integrated into the compost. The average absolute biodegradation reached 78% after only 65 days indicating a high metabolic activity in soil. Biodegradation of blends containing insoluble high-DA was used as a conservative test of blend biodegradation. Films were expected to reach full or very nearly-full carbon mineralization within 180 days.

### Example 2—CNC/Ch/CA Composite

As discussed in Example 1 above, the 1:1 CNC/Ch film has shown great oxygen barrier property and good water vapor barrier property at ambient condition. However, its water vapor barrier vapor property is still higher than most petroleum-based packaging plastics and its oxygen barrier property drops drastically at high humidity condition. Here, CA sourced from fruits was introduced into the CNC/Ch system to cross-link CNC and Ch to improve the barrier properties of CNC/Ch composites.

A series of CNC/Ch/CA composites with different degree of Ch acetylation (DA) and different CA loadings were prepared. Similar to the process discussed in Example 1 above, after mixing 0.5 wt. % CNC aqueous suspension and 0.5 wt. % Ch solution (Ch-EL) or suspension (Ch-H, Ch-M, Ch-L) and obtaining a homogenous suspension mixture, citric acid (CA) powder at various amounts (10 wt. %, 20 wt. %, 30 wt. %, 50 wt. %, and 100 wt. %, with respect to the total mass of CNC/Ch) were mixed at 500 rpm for 3 h. The resultant mixture was treated in an ultrasonic bath for 3 min. Next, the CNC/Ch/CA mixture suspension was cast on a substrate, e.g., PS petri dish. Next, the two-step solution casting was carried out by first air-drying in a fume hood for 2 days then heat-drying in a convection oven at 60° C. overnight.

The obtained CNC/Ch/CA samples were denoted as 1:1 CNC/Ch/z % CA, where z % is the citric acid loading in percentage with respect to the dry mass of CNC/Ch.

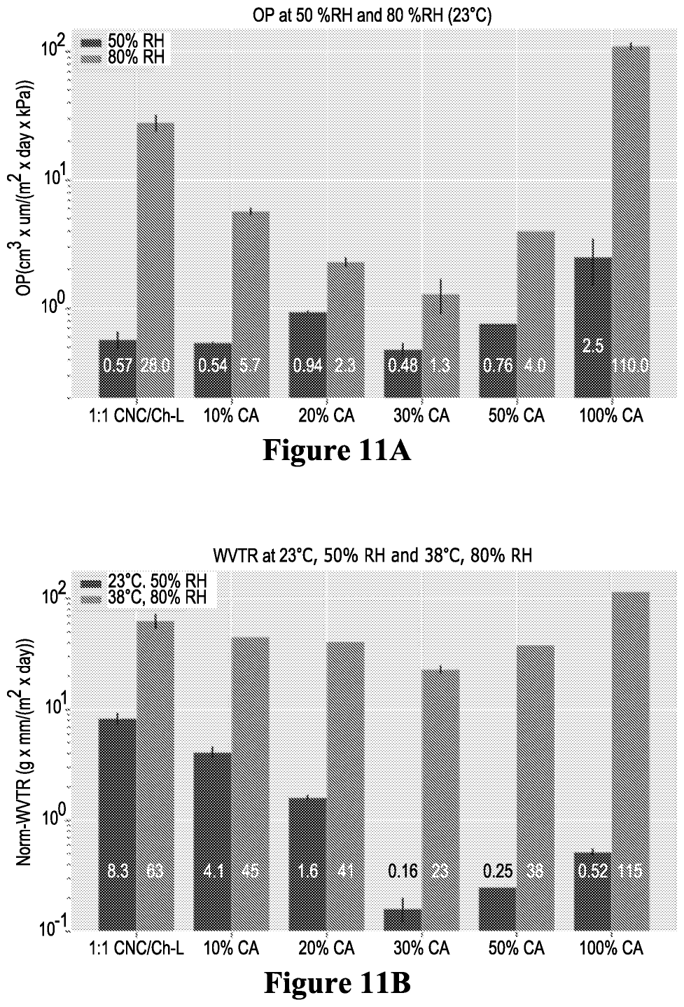

To investigate the optimal CA loading for the CNC/Ch/CA composite films, the barrier properties of five different loadings ranging from 10 wt. % to 100 wt. % with respect to the CNC/Ch mass have been tested. FIG. 11 shows the OP (11A) and N-WVTR (11B) of 1:1 CNC/Ch-L/CA at different CA loadings. As shown in FIG. 11A, with CA loading between 10 wt. % to 50 wt. %, the effects of CA on oxygen barrier property at 23° C., 50% RH is minor. For 1:1 CNC/Ch-L/30% CA, the OP slightly decreases from 0.57 to 0.48 cm³ μm m⁻² d⁻¹ kPa⁻¹. Excessive CA may be unfavorable on barrier performance as the 1:1 CNC/Ch-L/100% CA has a high OP at 2.5 cm³ μm m⁻² d⁻¹ kPa⁻¹. For OP at high humidity, e.g., at 80% RH, the addition of CA greatly reduces the moisture sensitivity. This is evidenced by the OP decreasing from 28 to 1.3 cm³ μm m⁻² d⁻¹ kPa⁻¹ for the 1:1 CNC/Ch-L/30% CA film demonstrating an over 20-fold improvement. Excessive CA loading leads to degrade the oxygen barrier properties as the 1:1 CNC/Ch-L/100% CA film having an extremely high OP at 110 cm³ μm m⁻² d⁻¹ kPa⁻¹.

Similar observation was found in N-WVTR results shown in FIG. 11B. At both 23° C., 50% RH and 38° C., 80% RH conditions, the optimal CA loading is 30 wt. %, and after which the N-WVTR increases again. For 1:1 CNC/Ch-L/30% CA, the N-WVTR at 23° C., 50% RH decreases from 8.3 to 0.16 g mm m⁻² d⁻¹, representing a 51-fold improvement on water vapor barrier property compared to the 1:1 CNC/Ch-L film. The N-WVTR keeps at a low level of 0.25 g mm m⁻² d⁻¹ for 1:1 CNC/Ch-L/50% CA film. When testing temperature increases to 38° C., the solubility of CA increases leading the improvement of N-WVTR to a lesser extent. The N-WVTR of 1:1 CNC/Ch-L/30% CA film at 38° C., 80% RH decreases from 63 to 23 g mm m⁻² d⁻¹, representing an approximately 3-fold improvement.

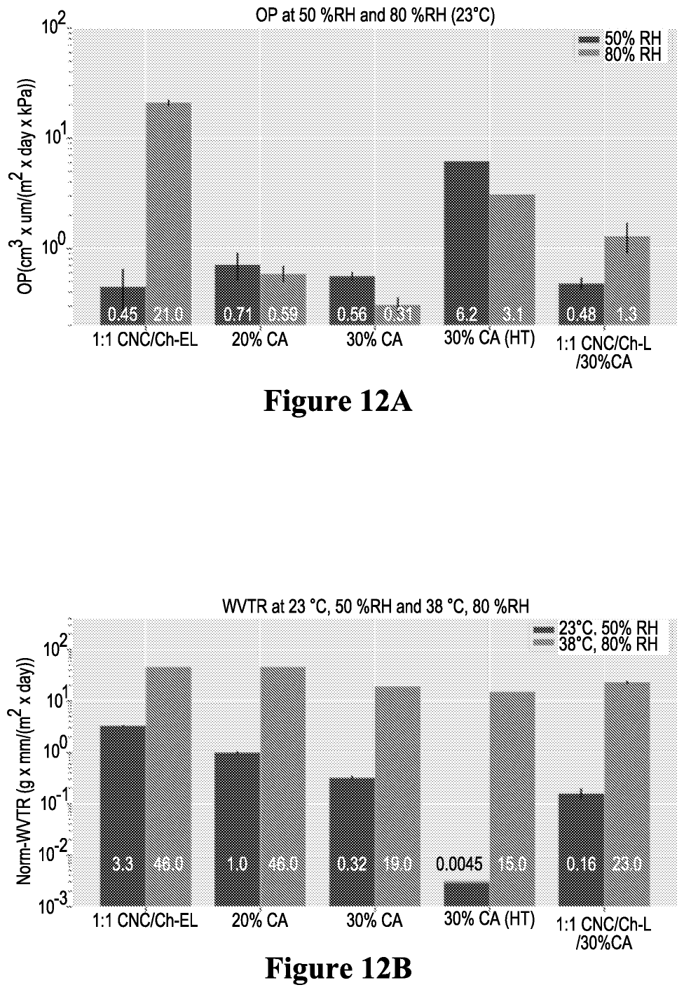

As 1:1 CNC/Ch-EL has superior barrier performance compared to 1:1 CNC/Ch-L, as discussed above, 1:1 CNC/Ch-EL/20% CA and 1:1 CNC/Ch-EL/30% CA ternary films were prepared. As shown in FIG. 12, the 1:1 CNC/Ch-EL/30% CA film outperforms the 1:1 CNC/Ch-EL/20% CA on both OP (FIG. 12A) and N-WVTR (FIG. 12B) at all conditions. This is consistent with the optimal CA loading study discussed in FIG. 11. At 23° C., 50% RH, the OP of 1:1 CNC/Ch-EL/30% CA is slightly higher than the 1:1 CNC/Ch-L/30% CA (0.48 cm³ μm m⁻² d⁻¹ kPa⁻¹) at 0.56 cm³ μm m⁻² d⁻¹ kPa⁻¹. However, at 80% RH, the OP of 1:1 CNC/Ch-EL/30% CA is 76% lower at only 0.31 cm³ μm m⁻² d⁻¹ kPa⁻¹. This value is lower than the OP of industrial high barrier standard EVOH at 1 cm³ μm m⁻² d⁻¹ kPa⁻¹ and PVDC at 2 cm³ μm m⁻² d⁻¹ kPa⁻¹ at same condition. Similar result is observed for water vapor barrier properties. At 23° C., 50% RH, the N-WVTR of 1:1 CNC/Ch-EL/30% CA film is 0.32 g mm m⁻² d⁻¹, representing a 10-fold improvement on water vapor barrier property compared with the base film. At 38° C., 80% RH, the N-WVTR of 1:1 CNC/Ch-EL/30% CA is lower than the 1:1 CNC/Ch-L/30% CA.

Several studies have reported that thermal treatment can effectively improve the barrier properties of cellulose films and chitin films due to the formation of irreversible hydrogen bonds and film densification (Sharma S, Zhang X, Nair S S, Ragauskas A, Zhu J, Deng Y. Thermally enhanced high performance cellulose nano fibril barrier membranes. RSC Adv. 2014, 4 (85), 45136-45142 and Xia J, Zhang Z, Liu W, Li VCF, Cao Y, Zhang W, Deng Y. Highly transparent 100% cellulose nanofibril films with extremely high oxygen barriers in high relative humidity. Cellulose 2018, 25 (7), 4057-4066). Therefore, the 1:1 CNC/Ch-EL/30% CA film was thermally annealed at 120° C. for 3 hours to obtain 1:1 CNC/Ch-EL/30% CA-HT (“HT” denotes “thermally treated”) sample. Excellent water vapor barrier performance at only 0.0045 g mm m⁻² d⁻¹ is achieved at 23° C., 50% RH (FIG. 12B). Compared with the untreated film and the 1:1 CNC/Ch-EL film, it is approximately 71 times and 723 times lower, respectively.

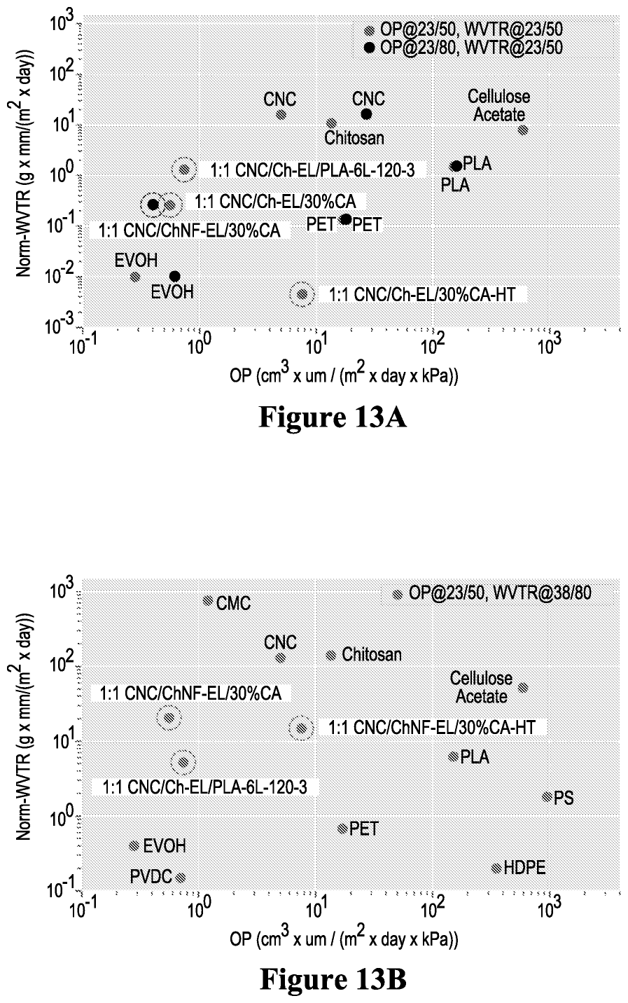

FIG. 13 compares the performance of 1:1 CNC/Ch-EL/30% CA and 1:1 CNC/Ch-EL/30% CA-HT with common packaging plastics in terms of oxygen and water vapor barrier properties at various conditions. As shown in FIG. 13A, at ambient condition, the 1:1 CNC/Ch-EL/30% CA film achieved a comparable oxygen barrier performance with ethylene vinyl alcohol (EVOH). Moreover, at elevated humidity, the 1:1 CNC/Ch-EL/30% CA film at 0.31 cm³ μm m⁻² d⁻¹ kPa⁻¹) outperforms the industrial standard oxygen barrier EVOH at 0.62 cm³ μm m⁻² d⁻¹ kPa⁻¹). The water vapor barrier property is also an order of magnitude better than the best bioplastics listed. The N-WVTR of 1:1 CNC/Ch-L/30% CA film at 0.16 g mm m⁻² d⁻¹ is only 19% higher than polyethylene terephthalate (PET) at 0.134 g mm m⁻² d⁻¹, which is commonly used for plastic water bottles. The thermally annealed 1:1 CNC/Ch-EL/30% CA-HT sample has excellent water vapor barrier property. Its N-WVTR (0.0045 g mm m⁻² d⁻¹) is only half of EVOH (0.0084 g mm m⁻² d⁻¹) and approximately 1770 times lower than cellulose acetate (7.98 g mm m⁻² d⁻¹). FIG. 13B lists the water vapor barrier performances of these packaging materials at elevated temperature and humidity (38° C., 80% RH). The N-WVTR of 1:1 CNC/Ch-EL/30% CA-HT film increases to 15 g mm m⁻² d⁻¹. Though its N-WVTR is lower than other cellulose and chitin derivatives, it is still an order of magnitude higher than polystyrene (PS) and PET. Laminating with other barriers may reduce the moisture sensitivity at elevated temperature and could fully utilize the excellent barrier properties of CNC/Ch-EL/CA composite films.

Mechanical properties of the samples were evaluated using a custom-built high-throughput mechanical characterization instrument (HTMECH). HTMECH measures the force and deformation of isolated film regions through transverse biaxial loading using an instrumented hemispherical contact tip (Sormana, J L, Chattopadhyay S, and J. Carson Meredith, High-throughput mechanical characterization of free-standing polymer films. Review of Scientific Instruments, 2005, 76, 6). In general, in order to achieve detectable rates, film samples were masked with self-adhesive aluminum foils bearing a circular hole in the center secured on both sides of the sample film.

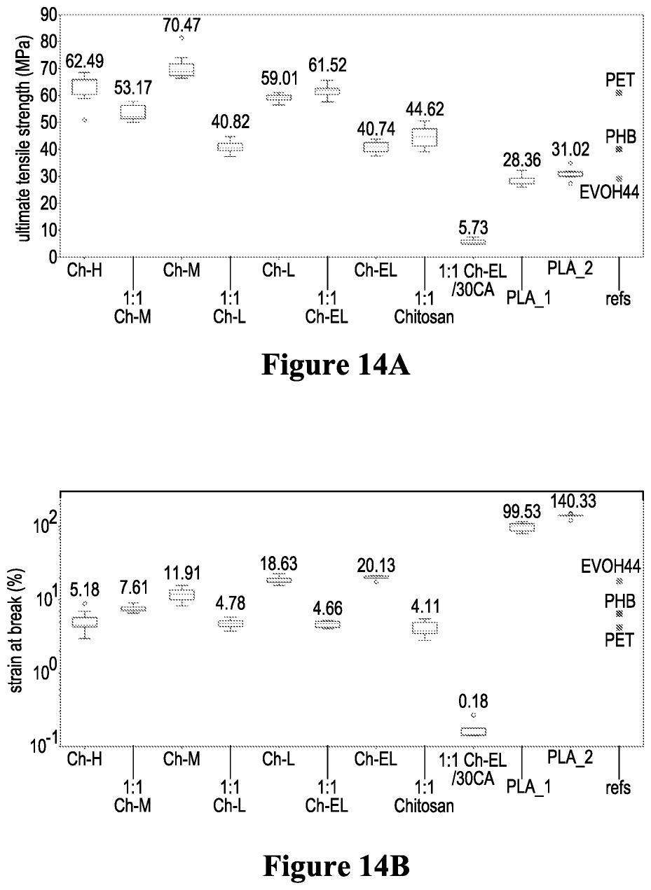

FIG. 14 compares the mechanical properties of common packaging plastics (EVOH, PET, PHB) with various CNC/Ch composites and CNC/Ch/CA composites. As shown in FIG. 14A, various renewable composites of the present disclosure, for example, 1:1 CNC/Ch-M, 1:1 CNC/Ch-L, 1:1 CNC/Ch-EL, and CNC/Ch coated PLA outperform at least one of the bioplastics listed in terms of tensile strength. As shown in FIG. 14B, various renewable composites of the present disclosure, for example 1:1 CNC/Ch-M, 1:1 CNC/Ch-L, 1:1 CNC/Ch-EL, and CNC/Ch coated on PLA substrate outperform at least one of the bioplastics listed in terms of tensile strength.

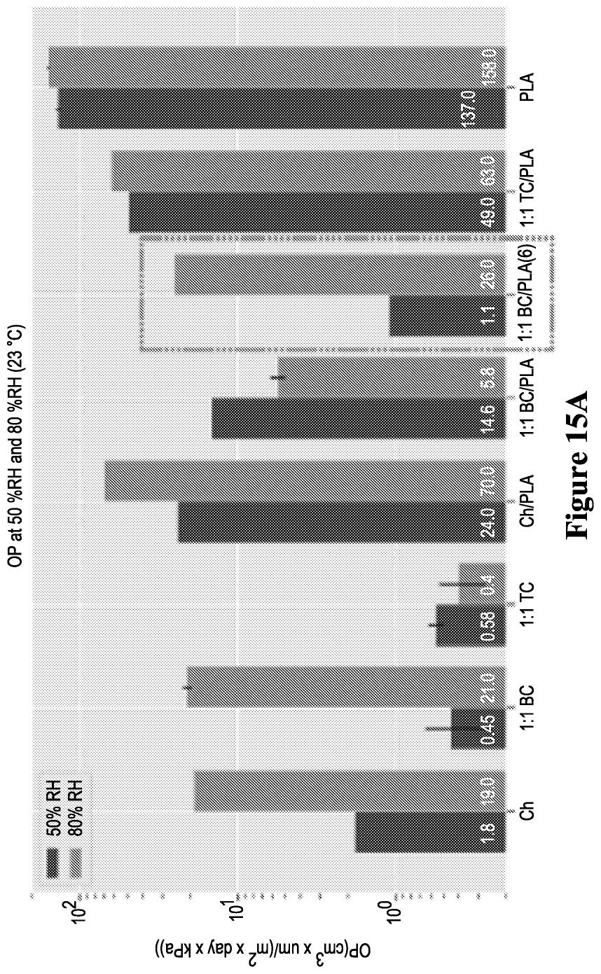

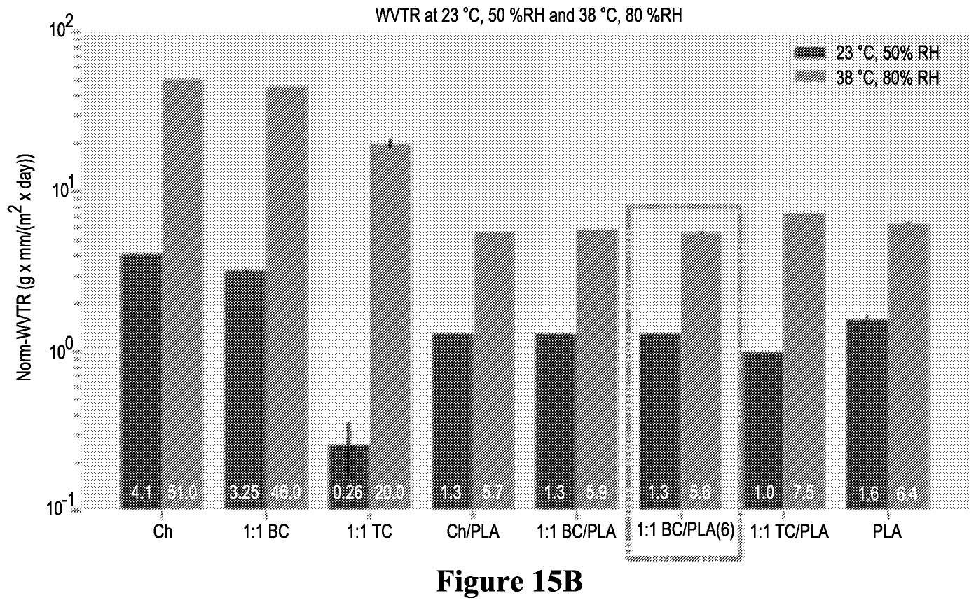

FIG. 15 is comparison of OP (FIG. 15A) and N-WVTR (FIG. 15B) of various coatings on a PLA substrate. Table 4 is comparison of total thickness of the composite film (CNC/Ch-EL coating and PLA substrate), oxygen transmission rate (OTR), OP, water vapor transmission rate (WVTR), and N-WVTR of various coatings on PLA substrate. As shown in FIG. 15A and Table 4, the OP of the composite film with 6 layers of 1:1 CNC/Ch-EL coatings is 1.1 cm³ μm m⁻² d⁻¹ kPa⁻¹, which is greatly improved compared to the PLA substrate, having an OP of 137 cm³ μm m⁻² d⁻¹ kPa⁻¹. Similarly, as shown in FIG. 15B and Table 4, the N-WVTR of the composite film with 6 layers of 1:1 CNC/Ch-EL coatings is 1.3 g mm m⁻² d⁻¹, which is greatly improved compared to 1:1 CNC/Ch-EL film.

TABLE 4
Oxygen and water vapor barrier properties of PLA and
PLA with CNC/Ch composite coatings at 23° C., 50% RH.

| | Total | | | | |
|---|---|---|---|---|---|
| | thickness of | | OP | | |
| | composite | OTR | (cm³ μm m⁻² | WVTR | N-WVTR |
| Sample | film (μm) | (cm³ m⁻² d⁻¹) | d⁻¹ kPa⁻¹) | (g m⁻² d⁻¹) | (g mm m⁻² d⁻¹) |
| 1:1 CNC/CH-EL | 32 | 1.40 | 0.45 | 98.6 | 3.2 |
| PLA | 35 | 409 | 137 | 45.8 | 1.6 |
| 1:1 CNC/Ch-EL/PLA | 36-37 | 17.8 | 6.2 | 37.4 | 1.3 |
| (3) | | | | | |
| 1:1 CNC/Ch-EL/PLA | 38 | 3.0 | 1.1 | 35.4 | 1.3 |
| (6) | | | | | |

### Example 3—CNC/Ch/TCA-Ad Composite

A series of CNC/Ch composites with propane-1,2,3-tricarboxylic acid (TCA) and/or adipic acid (Ad) as cross-linkers were prepared. As 1:1 the CNC/Ch-EL blend has shown superior barrier performance in both CNC/Ch composite and CNC/Ch/CA composite, the 1:1 CNC/Ch-EL blend was used to prepare CNC/Ch-EL/TCA-Ad composites. Similar to the process discussed in Example 1 above, after mixing 0.5 wt. % CNC aqueous suspension and 0.5 wt. % Ch-EL solution and obtaining a homogenous suspension mixture, TCA, Ad, or a mixture of TCA and Ad at various amounts (15 wt. % or 30 wt. % with respect to the total mass of CNC/Ch-EL) were added. The resultant mixture was treated in an ultrasonic bath for 5 min. Next, the CNC/Ch-EL/TCA-Ad suspension was cast on a substrate, and then first air-drying in a fume hood for 2 days before heating and curing in a convection oven overnight. To study the influence of curing temperature on the samples, all samples are heated and cured in a convection oven at 60° C. or 100° C.

The obtained CNC/Ch-EL/TCA-Ad samples were denoted as CNC/Ch-EL/z % TCA-Ad (x-y), where z % is the total TCA and Ad loading in percentage with respect to the dry mass of CNC/Ch-EL, x and y are the weight ratios between TCA and Ad. For example, CNC/Ch-EL/30% TCA-Ad (10-90) means the weight percentage of TCA and Ad being 30 wt. % of the total mass of CNC and Ch-EL, and the weight ratio between TCA and Ad are 10:90, respectively. As another example, CNC/Ch-EL/30% Ad means the weight percentage of Ad being 30 wt. % of the total mass of CNC and Ch. For all CNC/Ch-EL/TCA-Ad samples discussed in this example, the weight ratio between CNC and Ch-EL is 1:1.

Table 5 summaries the ultimate tensile strength (UTS) and elongation of CNC/Ch-EL/TCA-Ad samples with various TCA and Ad loadings. The samples have been heated and cured in an oven at either 60° C. or 100° C. For samples heated at 60° C., samples with Ad or a combination of TCA and Ad as cross-linkers show superior mechanical properties than samples with citric acid (CA) or TCA as cross-linkers. In addition, samples with a combination of TCA and Ad as cross-linkers show improved mechanical properties than samples with only Ad as cross-linker at the same loadings, though the difference is relatively small. Among all of the samples cured at 60° C., CNC/Ch-EL/30% TCA-Ad (25-75) shows the best strength and superior elongation. As for samples cured at 100° C., CNC/Ch-EL/30% CA, CNC/Ch-EL/15% TCA-Ad (10-90), and CNC/Ch-EL/30% TCA marked as “failed” as these samples cracked during the masking process. Furthermore, among other samples, CNC/Ch-EL/30% Ad shows the best strength but worst elongation. Furthermore, CNC/Ch-EL/15% Ad samples show superior strength and best elongation.

TABLE 5
Mechanical properties of CNC/Ch-EL/TCA-Ad composites.

| | UTS (MPa) | | Elongation (%) | |
|---|---|---|---|---|
| Samples | 60° C. | 100° C. | 60° C. | 100° C. |
| CNC/Ch-EL/15% Ad | 8.76 ± 1.9 | 9.37 ± 3.15 | 0.31 ± 0.1 | 0.56 ± 0.1 |
| CNC/Ch-EL/30% Ad | 7.94 ± 2.27 | 13.2 ± 2.73 | 0.44 ± 0.1 | 0.38 ± 0.2 |
| CNC/Ch-EL/30% CA | 5.38 ± 0.83 | Failed | 0.29 ± 0.1 | Failed |
| CNC/Ch-EL/15% TCA-Ad (10-90) | 9.20 ± 3.4 | Failed | 0.48 ± 0.1 | Failed |
| CNC/Ch-EL/30% TCA-Ad (10-90) | 7.69 ± 2.1 | 9.18 ± 1.88 | 0.42 ± 0.2 | 0.44 ± 0.1 |
| CNC/Ch-EL/30% TCA-Ad (25-75) | 10.57 ± 2.09 | 8.90 ± 2.15 | 0.46 ± 0.1 | 0.50 ± 0.1 |
| CNC/Ch-EL/30% TCA | 5.54 ± 2.26 | Failed | 0.2 ± 0.1 | Failed |
| CNC/Ch-EL | 6.94 ± 3.1 | Failed | 3 ± 1 | Failed |

Table 6 summaries the oxygen barrier property (OP) and water vapor barrier property (N-WVTR) of CNC/Ch/TCA-Ad samples at 23° C., 50% RH with various TCA and Ad loadings. As shown in Table 6, the CNC/Ch-EL/30% Ad and CNC/Ch-EL/30% TCA-Ad (10-90) composite samples show comparable OP with CNC/Ch-El sample. On the other hand, the CNC/Ch-EL composite samples with Ad, or a mixture of TCA and Ad as cross-linkers show great improvements in water vapor barrier properties. For example, the N-WVTR of CNC/Ch-EL/30% Ad and CNC/Ch-EL/30% TCA-Ad (25-75) are 0.48 and 0.43 g mm m⁻² d⁻¹, respectively, representing almost 10-fold improvements on water vapor barrier property compared with the CNC/Ch-EL film. The OP and N-MVTR of CNC/Ch-EL/30% TCA marked as “failed” as these samples cracked during the masking process.

TABLE 6
Oxygen and water vapor barrier properties of CNC/Ch-
EL/TCA-Ad composite coatings at 23° C., 50% RH.

| | OP | |
|---|---|---|
| | (cm³ μm m⁻² | N-WVTR |
| Samples | d⁻¹ kPa⁻¹) | (g mm m⁻² d⁻¹) |
| CNC/Ch-EL | 0.55 | 4.21 |
| CNC/Ch-EL/30% Ad | 0.89 | 0.48 |
| CNC/Ch-EL/30% TCA-Ad (50-50) | — | 0.82 |
| CNC/Ch-EL/30% TCA-Ad (10-90) | 0.81 | 0.75 |
| CNC/Ch-EL/30% TCA-Ad (25-75) | — | 0.43 |
| CNC/Ch-EL/30% TCA | Failed | Failed |

The KIT test was done to determine the oil resistance of the films. The standard kit-test was carried out from each formula according to the TAPPI T 559 cm-12 standard. Reagents with different rheology and surface energy were dropped on the films surface from a 13 mm height and wiped after 15 s by a clean cotton ball. The solution with the highest number that did not stain (darkened) the surface was considered as the passed kit number. Any denoted stain was reported as a failure. All of the composite samples shown in Tables 5 and 6 passed the KIT test, demonstrating good oil resistance property of the composite films.

Although the presently disclosed subject matter and its advantages have been described in detail, it should be understood that various changes, substitutions and alterations can be made herein without departing from the spirit and scope of the disclosed subject matter. Moreover, the scope of the present application is not intended to be limited to the particular embodiments of the process, machine, manufacture, and composition of matter, methods and processes described in the specification. As one of ordinary skill in the art will readily appreciate from the disclosed subject matter of the presently disclosed subject matter, processes, machines, manufacture, compositions of matter, methods, or steps, presently existing or later to be developed that perform substantially the same function or achieve substantially the same result as the corresponding embodiments described herein may be utilized according to the presently disclosed subject matter. Accordingly, the appended claims are intended to include within their scope such processes, machines, manufacture, compositions of matter, methods, or steps.

Various patents, patent applications, publications, product descriptions, protocols, and sequence accession numbers are cited throughout this application, the inventions of which are incorporated herein by reference in their entireties for all purposes.

1. A biodegradable composite comprising:
cellulose nanocrystals (CNC) and chitin (Ch),
wherein the Ch having a degree of acetylation (DA) from about 40% to about 95%, and
wherein, at 23° C., 50% relative humidity (RH), the biodegradable composite having an oxygen permeability equal to or lower than about 4 cm³ μm m⁻² d⁻¹ kPa⁻¹ and a water vapor transmission rate (WVTR) equal to or lower than about 18 g mm m⁻² d⁻¹.

2. The composite of claim 1, wherein the Ch has DA from about 40% to about 70%.

3. The composite of claim 1, wherein the composite is a cross-linked material.

4. The composite of claim 3, wherein the CNC and the Ch are cross-linked with one another through ionic bonds, electrostatic interactions, and/or hydrogen bonds.

5. The composite of claim 1, wherein an absolute biodegradation of the biodegradable composite is at least 50% after 65 days in aerobic environment.

6. The composite of claim 1, further comprising one or more fillers, wherein a weight ratio between the one or more fillers and a total weight of CNC and Ch is from about 1% to about 99%.

7. The composite of claim 6, wherein the one or more fillers are nano-clays, talcum, or calcium carbonate.

8. The composite of claim 1, wherein the Ch is produced by deacetylation of chitin.

9. The composite of claim 1, wherein a weight ratio between the CNC and Ch is from about 1:0 to about 0:1.

10. The composite of claim 9, wherein the weight ratio between the CNC and the Ch is about 1:1.

11. The composite of claim 1, wherein the biodegradable composite further comprises a cross-linker.

12. The composite of claim 11, wherein the cross-linker is citric acid.

13. The composite of claim 11, wherein the cross-linker is propane[ ]-[ ] 1,[ ] 2,[ ] 3,[ ]-tricarboxylic acid and/or adipic acid.

14. The composite of claim 11, the composite is exposed to a form of energy, wherein the form of energy comprises ultraviolet (UV) irradiation, gamma irradiation, or heat.

15. A method for producing a biodegradable composite, the method comprising:
forming a cellulose nanocrystal (CNC) suspension;
preparing chitin (Ch) powder from deacetylation of chitin powder;
forming a Ch liquid mixture;
mixing the CNC suspension and the Ch liquid mixture to form a mixture suspension;
coating the mixture suspension on a substrate; and
air-drying the mixture suspension to obtain a CNC/Ch composite film.

16. The method of claim 15, wherein the Ch liquid mixture is a Ch solution or a Ch suspension.

17. The method of claim 15, prior to coating the mixture suspension on the substrate, further comprising degassing in an ultrasonic bath.

18. The method of claim 15, wherein a concentration of the CNC suspension is about 0.5 wt. % and a concentration of the Ch liquid mixture is about 0.5 wt. %.

19. A method for producing a biodegradable composite, the method comprising:
forming a cellulose nanocrystal (CNC) aqueous suspension;
preparing soluble chitin (Ch) powder from deacetylation of chitin powder;
forming a Ch solution;
mixing the CNC aqueous suspension, the Ch solution, and one or more cross-linkers to form a mixture suspension;
coating the mixture suspension on a substrate;
air-drying the mixture suspension; and
heat-drying the mixture to obtain a CNC/Ch/cross-linker composite film.

20. The method of claim 19, wherein the one or more cross-linkers are at least one of citric acid, propane[ ]-[ ] 1,[ ] 2,[ ] 3,[ ]-tricarboxylic acid, and adipic acid.
